(19) United States
(12) Patent Application Publication
(10) Pub. No.: US 2013/0323557 A1
(43) Pub. Date: Dec. 5, 2013

(54) SECONDARY BATTERY AND METHOD FOR MANUFACTURING SAME

(71) Applicants: Toshiyuki Ariga, Hitachinaka (JP); Takashi Sasaki, Hitachinaka (JP); Sho Saimaru, Hitachinaka (JP)

(72) Inventors: Toshiyuki Ariga, Hitachinaka (JP); Takashi Sasaki, Hitachinaka (JP); Sho Saimaru, Hitachinaka (JP)

(21) Appl. No.: 14/001,287

(22) PCT Filed: Mar. 22, 2011
(86) PCT No.: PCT/JP2011/056815

§ 371 Date: Aug. 23, 2013

(51) Int. Cl. H01M 2/26

(52) U.S. Cl. CPC H01M 2/263
USPC 429/94; 29/623.1

(57) ABSTRACT

A secondary battery includes a vessel exterior provided with positive and negative electrode external terminals; an electrode group in which positive and negative electrode plates are wound while allowing a separator to intervene therebetween, and collector portions are provided at the both ends thereof; a shaft core in which the positive and negative electrode plates are wound and which has positive and negative electrode shaft core portions at both ends thereof, the positive and negative electrode shaft core portions being insulated from each other by an insulation portion; and positive and negative electrode collectors which are supported by the vessel exterior and constitute a current path reaching the positive and negative electrode external terminals from the electrode group, the positive and negative electrode shaft core portions being joined with collecting portion of the positive and negative electrode plates and also welded to the positive and negative electrode collectors, respectively.

### TECHNICAL FIELD

The present invention relates to a secondary battery represented by square lithium ion secondary batteries suitable for vehicle mounting and a method for manufacturing same.

### BACKGROUND ART

Hitherto, square batteries have been known as a battery from which a high volume density is obtained as compared with cylindrical batteries. The square batteries have a flat wound electrode group obtained by superimposing band-like positive electrode and negative electrode via a separator and winding, a square battery case having the electrode group housed therein, and an electrolytic solution filled in the battery case.

In the both end portions of the winding shaft direction of the flat wound electrode group, a non-coating portion of each of the positive electrode and the negative electrode is protruded, and an electrode terminal or a collector is connected to this non-coating portion. In the square batteries adopting such a configuration, it is contrived to reduce the connection resistance through minimization of the energizing path, thereby enhancing an output. In addition, such a configuration is also effective for miniaturization.

As for the connection state between the flat wound electrode group and the collector, for example, a storage element of PTL 1 is proposed.

In the storage element described in PTL 1, a platy sheet connecting portion is inserted from an end surface of a non-coating portion protruded from the flat wound electrode group into the inside, thereby connecting the both to each other.

### CITATION LIST

### Patent Literature

PTL 1: Japanese Patent No. 4061938

### SUMMARY OF THE INVENTION

### Technical Problem

In the storage element of PTL 1, on the occasion of inserting the sheet-shaped connecting portion into a non-coating wound inner circumferential portion at the both ends present in the shaft direction end portion of the flat wound electrode group, there is a concern that a metal foil is scared. For example, there is a concern that the metal foil is folded or deformed, a winding center position of the foil to be expanded is mistaken, or at the time of inserting the sheet-shaped connecting portion, a part thereof is bitten. Accordingly, it is necessary to carefully perform work of inserting the sheet-shaped connecting portion into the end surface of the flat wound electrode group so as not to scar the metal foil, and an improvement of the workability is required.

### Solution to Problem

(1) A secondary battery according to a first aspect of the present invention is a secondary battery including a vessel exterior provided with positive and negative electrode external terminals; an electrode group in which positive and negative electrode plates are wound while allowing a separator to intervene therebetween, and collector portions are provided at the both ends thereof; a shaft core in which the positive and negative electrode plates are wound and which has positive and negative electrode shaft core portions at the both ends thereof, the positive and negative electrode shaft core portions being insulated from each other by an insulation portion; and positive and negative electrode collectors which are supported by the vessel exterior and constitute a current path reaching the positive and negative electrode external terminals from the electrode group, the positive and negative electrode shaft core portions being joined with collecting portion laminates of the positive and negative electrode plates and also welded to the positive and negative electrode collectors, respectively.
(2) A second aspect of the present invention is concerned with the secondary battery of the first aspect, wherein the positive and negative electrode shaft core portions have a positive electrode spreading portion and a negative electrode spreading portion which push and expand the positive electrode plate laminate and the negative electrode plate laminate, respectively from the insides at the both end surfaces of the electrode group and are joined with the positive electrode plate and the negative electrode plate, respectively and have positive and negative electrode connection protrusions which are protruded from the both end surfaces of the electrode group and mechanically and electrically connected to the positive and negative electrode collectors, respectively.
(3) A third aspect of the invention is concerned with the secondary battery of the second aspect, wherein the positive electrode spreading portion includes a pair of positive electrode blades dividing the positive electrode plate in the both end surfaces of the electrode group; the pair of the positive electrode blades are joined with the inner peripheries of the divided laminates, respectively; the negative electrode spreading portion includes a pair of negative electrode blades dividing the negative electrode plate laminate in the both end surfaces of the electrode group; and the pair of the negative electrode blades are joined with the inner peripheries of the divided laminates, respectively.
(4) A fourth aspect of the invention is concerned with the secondary battery of the third aspect, wherein plural positive electrode connection protrusions are provided at prescribed intervals at the end surface of the positive electrode shaft core portion; the positive electrode collector is integrated with a lid of the vessel exterior, extends toward a bottom portion of the battery vessel along the width direction side surface of the battery vessel, and has openings into which the plural positive electrode connection protrusions are inserted, respectively; plural negative electrode connection protrusions are provided at prescribed intervals at the end surface of the negative electrode shaft core portion; the negative electrode collector is integrated with a lid of the vessel exterior, extends toward a bottom portion of the battery vessel along the width direction side surface of the battery vessel, and has openings into which the plural negative electrode connection protrusions are inserted, respectively; the respective positive electrode connection protrusions are mechanically and electrically connected to the openings of the positive electrode collector, respectively; and the respective negative electrode connection protrusions are mechanically and electrically connected to the openings of the negative electrode collector, respectively.
(5) A fifth aspect of the invention is concerned with the secondary battery of the fourth aspect, wherein the respective positive electrode connection protrusions are provided in the both end portions of the end surface of the positive electrode shaft core portion, respectively; the respective openings of the positive electrode collector are provided on the lid side and the bottom portion side of the battery vessel, respectively; the respective negative electrode connection protrusions are provided in the both end portions of the end surface of the negative electrode shaft core portion, respectively; and the respective openings of the negative electrode collector are provided on the lid side and the bottom portion side of the battery vessel, respectively.
(6) A sixth aspect of the present invention is concerned with the secondary battery of the second or third aspect, wherein only one of the positive electrode connection protrusions is provided at the end surface of the positive electrode shaft core portion; the positive electrode collector is integrated with a lid of the vessel exterior, extends toward a bottom portion of the battery vessel along the width direction side surface of the battery vessel, and has an opening into which the one positive electrode connection protrusion is inserted; only one of the negative electrode connection protrusions is provided at the end surface of the negative electrode shaft core portion; the negative electrode collector is integrated with a lid of the vessel exterior, extends toward a bottom portion of the battery vessel along the width direction side surface of the battery vessel, and has an opening into which the one negative electrode connection protrusion is inserted; the respective positive electrode connection protrusion is inserted into the opening of the positive electrode collector for mechanical and electrical connection, respectively; and the negative electrode connection protrusion is inserted into the opening of the negative electrode collector for mechanical and electrical connection, respectively.
(7) A seventh aspect of the present invention is concerned with the secondary battery of the sixth aspect, wherein the positive electrode connection protrusion is provided in an end portion on the lid side of the end surface of the positive electrode shaft core portion; the opening of the positive electrode collector is provided on the lid side; the negative electrode connection protrusion is provided in an end portion on the lid side of the end surface of the negative electrode shaft core portion; and the opening of the negative electrode collector is provided on the lid side.
(8) An eighth aspect of the present invention is concerned with the secondary battery of the seventh aspect, wherein the positive electrode collector extends toward the bottom portion to a position exceeding the positive electrode connection protrusion along the width direction side surface, and the negative electrode collector extends toward the bottom portion to a position exceeding the negative electrode connection protrusion along the width direction side surface.
(9) A ninth aspect of the present invention is concerned with the secondary battery of any one of the first to eighth aspects, wherein the insulation portion has a thin-walled joint portion at the bond ends thereof, and the positive electrode shaft core portion and the negative electrode core portion sandwich the thin-walled joint portion therebetween and are adhered with an insulating adhesive.
(10) A tenth aspect of the present invention is concerned with the secondary battery of the ninth aspect, wherein the positive electrode shaft core portion and the negative electrode shaft core portion sandwich the thin-walled joint portion therebetween by folding one sheet of metal plate in a U-shape.
(11) An eleventh aspect of the present invention is concerned with the secondary battery of the ninth aspect, wherein in the positive electrode shaft core portion and the negative electrode shaft core portion, two sheets of metal plates are welded to the both surfaces of the thin-walled joint portion.
(12) A twelfth aspect of the present invention is concerned with the secondary battery of any one of the third to eleventh aspects, wherein in base ends of the pair of the positive electrode blades and the pair of the negative electrode blades, a groove for setting up a folding position of each of the pairs of positive and negative electrode blades is formed.
(13) A thirteenth aspect of the present invention is concerned with the secondary battery of the first aspect, wherein the positive electrode shaft core portion and the negative electrode shaft core portion are connected to each other by allowing one sheet of metal plate to be fitted into the end surface of the insulation portion.
(14) A fourteenth aspect of the present invention is concerned with the secondary battery of any one of the first to thirteenth aspects, wherein the positive electrode plate includes a metal foil composed of aluminum or an aluminum alloy and a positive electrode joining agent layer coated on the both surfaces of the metal foil; the positive electrode shaft core portion is formed of a metal plate composed of aluminum or an aluminum alloy; the negative electrode plate includes a metal foil composed of copper, a copper alloy, nickel, or a nickel alloy and a negative electrode joining agent layer coated on the both surfaces of the metal foil; the negative electrode shaft core portion is formed of a metal plate composed of copper, a copper alloy, nickel, or a nickel alloy; and the positive and negative electrode joining agent layers face each other and occlude and release a lithium ion.
(15) A method for manufacturing a secondary battery according to a fifteenth aspect of the present invention includes a step of fabricating a vessel exterior having positive and negative electrode external terminals provided therein; a step of winding positive and negative electrode plates while allowing a separator to intervene therebetween, to fabricate an electrode group provided with collecting portions at the both ends thereof; a step of fabricating a shaft core in which the positive and negative electrode plates are wound and which has positive and negative electrode shaft core portions at the both ends thereof, the positive and negative electrode shaft portions being insulated from each other by an insulation portion; a step of fabricating positive and negative electrode collectors which are supported on the vessel exterior and constitute a current path reaching the positive and negative electrode external terminals from the electrode group; a step of joining the positive and negative electrode shaft core portions with collecting portion laminates of the positive and negative electrode plates; and a step of welding the positive and negative electrode shaft core portions to the positive and negative electrode collectors, respectively.

### Advantageous Effects of Invention

According to the present invention, it is possible to prevent a lowering of strength of a supporting portion of a wound electrode group to be caused due to vibration of a secondary battery from occurring.

### BRIEF DESCRIPTION OF DRAWINGS

FIG. 1 is an appearance view showing a first embodiment of a lithium ion secondary battery according to the present invention.

FIG. 2 is an exploded perspective view of a lithium ion secondary battery.

FIG. 3 is a perspective view showing a flat wound electrode group of a lithium ion secondary battery.

FIG. 4 is a plan view showing a positive or negative electrode plate.

FIG. 5 is a perspective view showing a shaft core of a lithium ion secondary battery.

FIG. 6 is an exploded perspective view of a shaft core.

FIG. 7 is a perspective view showing an insulation portion of a shaft core.

FIG. 8 is a plan view showing a material of a positive or negative electrode shaft core portion of a shaft core.

FIG. 9 is a view explaining details of a positive or negative electrode shaft core portion.

FIG. 10 is a transverse cross-sectional view of a lithium ion secondary battery.

FIG. 11(a) is a view explaining connection between a negative electrode shaft core portion and a negative electrode collector in a negative electrode side end portion of a wound electrode group and is a XI-XI line cross-sectional view of FIG. 15, and FIG. 11(b) is an enlarged view of a principal part thereof.

FIG. 12 is a perspective view showing a winding step by a winding device.

FIG. 13 is an enlarged view showing connection between a shaft core and a collector of the lithium ion secondary battery of FIG. 1.

FIG. 14 shows an enlarged cross section of a non-coating portion (collecting portion) of a negative electrode in a negative electrode side end portion of a wound electrode group and is a XIV-XIV line cross-sectional view of FIG. 15, in which FIG. 14(a) shows a state before opening a negative electrode plate laminate by a negative electrode spreading protrusion, and FIG. 14(b) shows a state after opening the negative electrode plate laminate.

FIG. 15 is a side view of a wound electrode group.

FIG. 16 is an exploded perspective view showing a shaft core in a second embodiment of a lithium ion secondary battery according to the present invention.

FIG. 17 is an exploded perspective view showing a shaft core in a third embodiment of a lithium ion secondary battery according to the present invention.

FIG. 18 is an exploded perspective view showing a shaft core in a fourth embodiment of a lithium ion secondary battery according to the present invention.

FIG. 19 is a plan view showing a state before assembling a positive or negative electrode shaft core portion in a shaft core of a fifth embodiment of a lithium ion secondary battery according to the present invention.

FIG. 20 is an enlarged view showing connection between a shaft core and a connection plate in a fifth embodiment.

FIG. 21 is a transverse cross-sectional view showing a wound electrode group in a sixth embodiment of a lithium ion secondary battery according to the present invention.

FIG. 22 is a plan view showing a positive or negative electrode shaft core portion in a shaft core of FIG. 21.

FIG. 23 is a front view showing a shaft core of FIG. 21.

### DESCRIPTION OF EMBODIMENTS

An example in which the present invention is applied to a square lithium ion secondary battery is described by reference to the accompanying drawings.

### First Embodiment

### Configuration of Square Battery

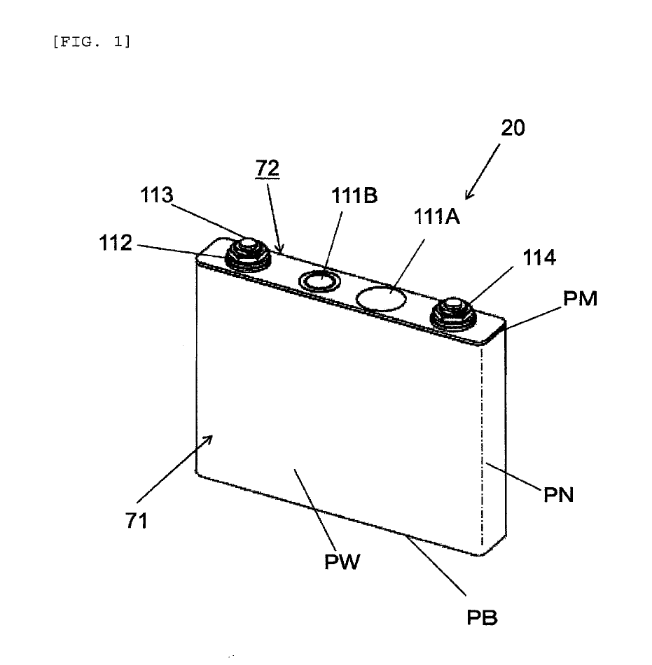

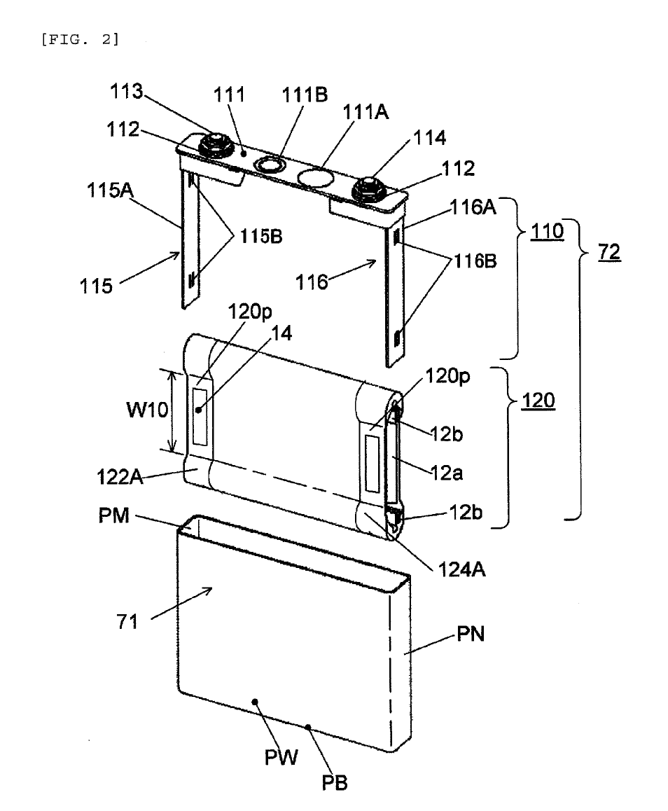

As shown in FIG. 1, a lithium ion secondary battery 20 is configured to include a vessel 71 having an opening in one end portion thereof and a power generation element assembly 72 shown in FIG. 2, which is housed within the vessel 71. The vessel 71 having a rectangular parallelepiped shape includes a pair of wide side surfaces PW, a pair of narrow side surfaces PN, a flat rectangular bottom surface PB, and a rectangular opening portion PM opposing to the bottom surface PB.

### [Power Generation Element Assembly]

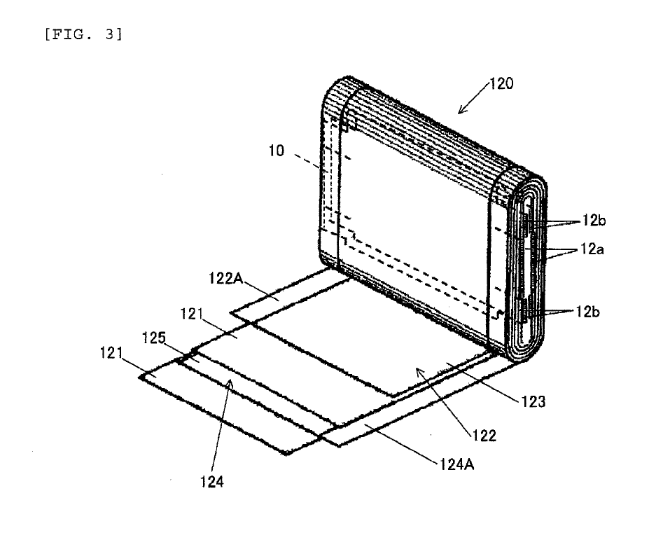

As shown in FIG. 2, the power generation element assembly 72 is provided with a lid assembly 110 and a flat wound electrode group 120 shown in FIG. 3.

### [Lid Assembly]

The lid assembly 110 is provided with a lid 111 covering the opening PM of the vessel 71, positive and negative electrode external terminals 113 and 114 protruding from the lid 111 via an insulation seal member 112, and positive and negative electrode collectors 115 and 116 connected to the positive and negative electrode external terminals 113 and 114, respectively. The lid 111 is laser welded to the opening PM to seal the vessel 71. In the lid 111, a liquid injection port 111A for injecting an electrolytic solution into the vessel 71 is provided, and after injecting the electrolytic solution, the liquid injection port 111A is sealed by a liquid injection plug. The lid 111 is also provided with a gas discharge valve 111B, and when the pressure within the vessel 71 increases, the gas discharge valve 111B is opened to discharge a gas in the inside, thereby reducing the pressure within the vessel 71.

Incidentally, in this description, the vessel 71 covered by the lid 111 is called a vessel exterior.

All of the vessel 71, the lid 111, and the positive electrode external terminal 113 are made of an aluminum alloy, and the negative electrode external terminal 114 is made of a copper alloy. As the electrolytic solution, for example, an electrolytic solution obtained by dissolving 1 mole/L of lithium hexafluorophosphate in a mixed solution of ethylene carbonate (EC), dimethyl carbonate (DMC), and diethyl carbonate (DEC) in a volume ratio of 1/1/1 is used.

The positive and negative electrode external terminals 113 and 114 and the positive and negative electrode collectors 115 and 116 are electrically insulated from the lid 111, respectively by the insulation seal members 112. The positive and negative electrode external terminals 113 and 114 are each a terminal for supplying an electric power to an external load, or charging the flat wound electrode group 120 of the inside by an external generated electric power.

The positive electrode collector 115 has a flat plate 115A extending in the direction of the secondary battery bottom portion PB along the positive electrode side end surface of the winding shaft direction of the flat wound electrode group 120, namely the positive electrode side narrow surface PN of the battery vessel 71. While illustration is omitted, an upper end of the flat plate 115A is connected to the positive electrode external terminal 113. The flat plate 115A is provided with a pair of shaft core fixing openings 115B which are separated at a prescribed distance from each other in the vertical direction.

Similarly, the negative electrode collector 116 has a flat plate 116A extending in the direction of the secondary battery bottom portion PB along the negative electrode side end surface of the winding shaft direction of the flat would electrode group 120, namely the negative electrode side narrow surface PN of the battery vessel 71. While illustration is omitted, an upper end of the flat plate 116A is connected to the negative electrode external terminal 114. The flat plate 116A is provided with a pair of shaft core fixing openings 116B which are separated at a prescribed distance from each other in the vertical direction.

While described later in detail, the positive and negative electrode collectors 115 and 16 are each electrically and mechanically connected to a shaft core 10 of the wound electrode group 120. Metal-made positive and negative electrode connection protrusions 11b and 12b of positive and negative electrode shaft core portions 11 and 12 are inserted into the shaft core fixing openings 115B and 116B, respectively and laser welded. In addition, non-coating portions 122A and 124A of the electrode group 120 are flattened in a planar state, and their planar portions 120P are sandwiched between metal-made positive and negative electrode spreading blades 11a and 12a of the shaft core 10 and a connection ribbon 14 and ultrasonically joined.

In this way, one of the characteristic features of the present invention resides in the matter that the collectors 115 and 116 and the shaft core portions 11 and 12, and the electrode group 120 and the shaft core portions 11 and 12, are electrically and mechanically connected to each other.

### [Flat Wound Electrode Group]

As shown in FIG. 3, the flat wound electrode group 120 is configured such that after a separator 121 is wound around the flat shaft core 10, a negative electrode plate (negative electrode sheet) 124, a separator 121, a positive electrode plate (positive electrode sheet) 122, and a separator 121 are successively wound in a flat state. The electrode plate of the outermost periphery of the flat wound electrode group 120 is the negative electrode plate 124, and a separator 121 is wound on the further outside thereof.

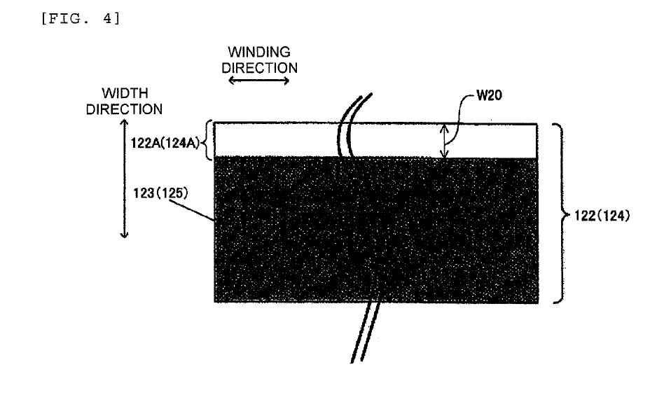

As shown in FIG. 4, the positive and negative electrode plates 122 and 124 have positive and negative electrode foils and positive and negative electrode joining agent layers 123 and 125, respectively each having an active material joining agent coated on the both surfaces of the positive or negative electrode foil. In one end portion of the width direction (direction orthogonal to the winding direction) of each of the electrode foils, positive and negative electrode collecting portions (positive and negative electrode non-coating parts) 122A and 124A not coated with an active material joining agent are provided, respectively. The positive and negative electrode collecting portions 122A and 124A are each a region where the metal surface of each of the electrode foils is exposed. The positive and negative electrode collecting portions 122A and 124A are formed at positions opposing to each other in the width direction of each of the electrode foils.

The negative electrode joining agent layer 125 is configured such that it is larger in the width direction than the positive electrode joining agent layer 123, so that the positive electrode joining agent layer 123 is always inserted into the negative electrode joining agent layer 125.

Incidentally, though the separator 121 is wider in the width direction than the negative electrode joining agent layer 125, its both ends are wound in the insides of the width direction ends of the positive electrode collecting portions 122A and the negative electrode collecting portion 124A where the metal foil surface is exposed, and thus, they do not impair a step of bundling the position electrode collecting portion 122A and the negative electrode collecting portion 124A and welding them to each other.

The negative electrode plate 124 was fabricated in the following manner. To 100 parts by weight of an amorphous carbon powder as a negative electrode active material, 10 parts by weight of polyvinylidene fluoride (hereinafter referred to as “PVDF”) as a binder were added, to which was then added N-methylpyrrolidone (hereinafter referred to as “NMP”) as a dispersion solvent, followed by kneading to fabricate a negative electrode joining agent. This negative electrode joining agent was coated on the both surfaces of a copper foil having a thickness of 10 μm while leaving the plain negative electrode collecting portion 124A. Thereafter, the resultant was dried, pressed, and cut to obtain the negative electrode plate 124 in which a thickness of the negative electrode active material-coated portion not containing a copper foil was 70 μm.

The positive electrode plate 122 was fabricated in the following manner. To 100 parts by weight of lithium manganate (chemical formula: LiMn₂O₄) as a positive electrode active material, 10 parts by weight of flaky graphite as a conductive material and 10 parts by weight of PVDF as a binder were added, to which was then added NMP as a dispersion solvent, followed by kneading to fabricate a positive electrode joining agent. This positive electrode joining agent was coated on the both surfaces of an aluminum foil having a thickness of 20 μm while leaving the plain positive electrode collecting portion 122A. Thereafter, the resultant was dried, pressed, and cut to obtain the positive electrode plate 122 in which a thickness of the positive electrode active material-coated portion not containing an aluminum foil was 90 μm.

### [Shaft Core]

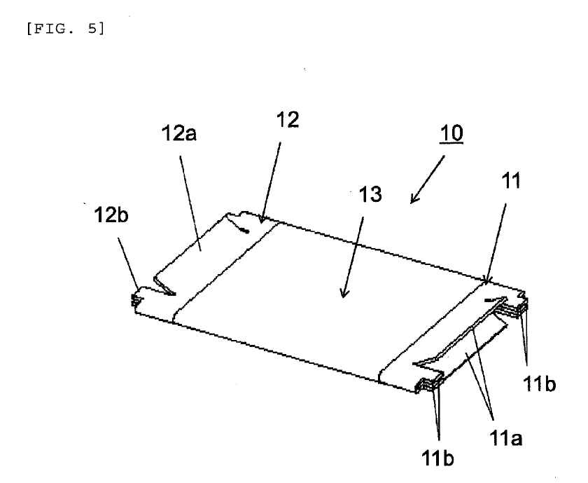

The shaft core 10 is described by reference to FIGS. 5 to 9.

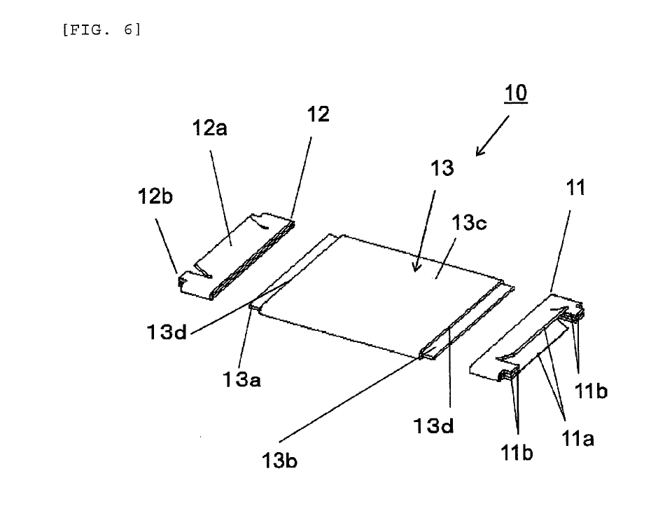

As shown in FIGS. 5 to 6, the flat shaft core 10 is formed in a substantially rectangular thin plate shape as a whole. The flat shaft core 10 is provided with an insulation portion 13 in the center of the longitudinal direction thereof and the positive electrode shaft core portion 11 and the negative electrode shaft core portion 12 which are respectively installed in positive and negative electrode joint portions 13a and 13b of the both end portions of the longitudinal direction of the insulation portion 13.

In the central portions of the outer end portions of the positive electrode shaft core portion 11 and the negative electrode shaft core portion 12, the positive electrode spreading portion 11a and the negative electrode spreading portion 12a are provided, respectively. As described later, the positive electrode spreading portion 11a and the negative electrode spreading portion 12a are joined with the positive and negative electrode collecting portions 122A and 124A, respectively. In addition, in the both ends of the outer end portions of the positive electrode shaft core portion 11 and the negative electrode shaft core portion 12, each four of the positive electrode connection protrusion 11b and the negative electrode connection protrusion 12b are provided so as to sandwich the positive electrode spreading portion 11a and the negative electrode spreading portion 12a therebetween, respectively. The each four positive electrode connection protrusions 11b and negative electrode connection protrusions 12b are inserted into the shaft core fixing openings 115B and 116B of the positive and negative electrode collectors 115 and 116, respectively and laser welded.

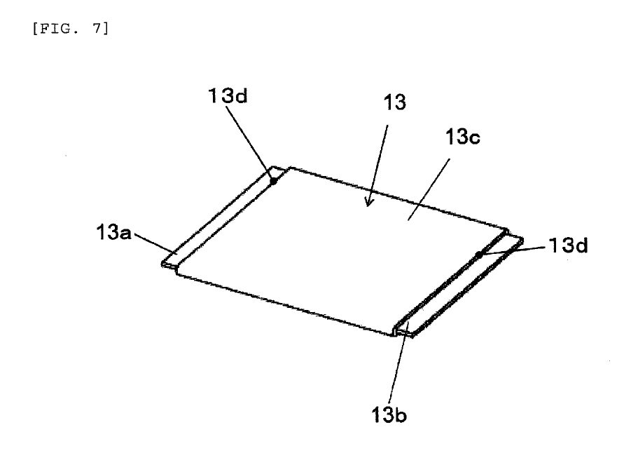

FIG. 7 is a perspective view of the insulation portion 13. The insulation portion 13 is fabricated by, for example, a PPS resin having high heat resistance. The insulation portion 13 is configured of a thick plate main body 13c in the central portion and the thin plate joint portions 13a and 13b protruding from the both ends of the main body 13c. In a connection portion between the thick plate main body 13c and each of the thin plate joint portions 13a and 13b, a level difference 13d is formed. A size of this level difference 13d is made substantially equal to the thickness of the material of each of the positive electrode shaft core portion 11 and the negative electrode shaft core portion 12. In consequence, on the front and rear surfaces of the shaft core 10, a level difference-free flat surface is formed.

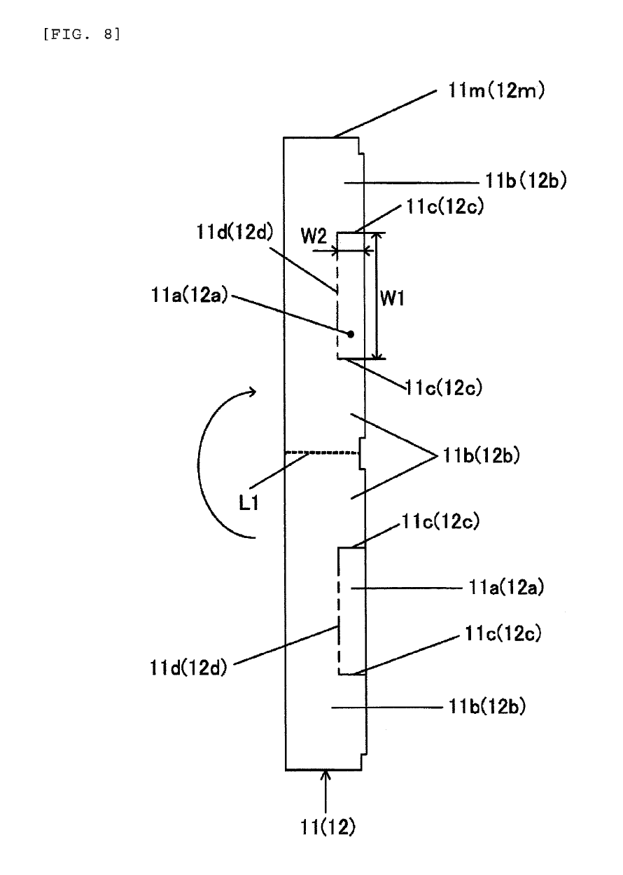

FIG. 8 is a view showing the material of each of the positive electrode shaft core portion 11 and the negative electrode shaft core portion 12.

The positive electrode shaft core portion 11 is fabricated using a thin plate-shaped positive electrode metal material 11m made of aluminum or an aluminum alloy similar to the positive electrode plate 122. In the positive electrode metal material 11m, a V groove is formed along a center line L1. The positive electrode metal material 11m is folded in half in a U-shape as shown by an arrow while making the center line L1 as a folding line, whereby the positive electrode joint portion 13a of the insulation portion 13 is sandwiched therebetween. At that time, the positive electrode shaft core portion 11 and the insulation portion 13 are joined with each other using an insulating pressure-sensitive adhesive (adhesive).

In the positive electrode metal material 11m, notches 11c and V grooves 11d are also formed in line symmetry relative to the center line L1. After joining the positive electrode joint portion 13a with the insulation portion 13, when the positive electrode metal material 11m is cut open along a pair of the notches 11c while making the V grooves 11d as a folding line, protrusions (blades) 11a are formed. On the both sides of a pair of the protrusions 11a, regions serving as two pairs of positive electrode connection protrusions 11b in line symmetry relative to the center line L1 are provided. When the positive electrode metal material 11m is folded in a U-shape and adhered to the insulation portion 13, these two pairs of regions form the positive electrode connection protrusions 11b, respectively.

The negative electrode shaft core portion 12 is fabricated using a thin plate-shaped negative electrode metal material 12m made of copper or a copper alloy similar to the negative electrode plate 124. In the negative electrode metal material 12m, a V groove is formed along the center line L1. The negative electrode metal material 12m is folded in half in a U-shape as shown by an arrow while making the center line L1 as a folding line, whereby the negative electrode joint portion 13b of the insulation portion 13 is sandwiched therebetween. At that time, the negative electrode shaft core portion 12 and the insulation portion 13 are joined with each other using an insulating pressure-sensitive adhesive (adhesive).

In the negative electrode metal material 12m, notches 12c and V grooves 12d are also formed in line symmetry relative to the center line L1. After joining the negative electrode joint portion 13d with the insulation portion 13, when the negative electrode metal material 12m is cut open along a pair of the notches 12c while making the V grooves 12d as a folding line, protrusions (blades) 12a are formed. On the both sides of a pair of the protrusions 12a, regions serving as two pairs of negative electrode connection protrusions 12b in line symmetry relative to the center line L1 are provided. When the negative electrode metal material 12m is folded in a U-shape and adhered to the insulation portion 13, these two pairs of regions form the negative electrode connection protrusions 12b, respectively.

In this way, the positive electrode shaft core portion 11 and the negative electrode shaft core portion 12 are adhered and fixed to the joint portions 13a and 13b, respectively by an adhesive material. As the adhesive material, for example, an acrylic resin is used. In consequence, the positive electrode shaft core portion 11 and the negative electrode shaft core portion 12 are connected to each other while being insulated from each other by the insulation portion 13.

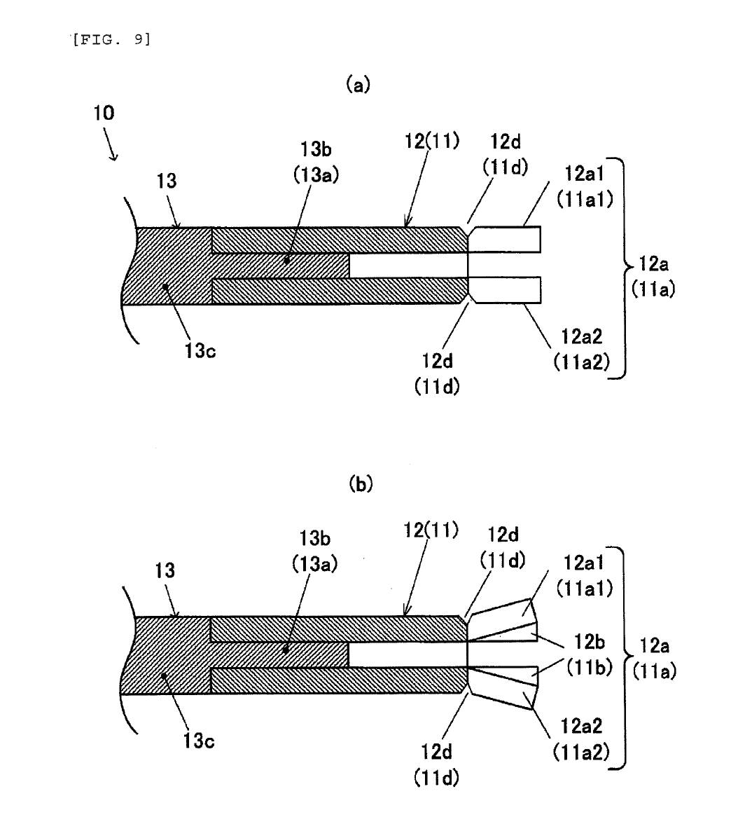

FIG. 9 shows a laminate structure of the shaft core portion 10. As shown in FIG. 9(a), the positive and negative electrode joint portions 13a and 13b protruding from the main body 13c of the insulation portion 13 are respectively joined with the positive and negative electrode shaft core portions 11 and 12 folded in half in a U-shape as described above, and those shaft core portions 11 and 12 are provided with the positive electrode spreading portion 11a and the negative electrode spreading portion 12a, respectively. The positive electrode spreading portion 11a has a pair of blades 11a1 and 11a2 opposing to each other, and the negative electrode spreading portion 12a has a pair of blades 12a1 and 12a2 opposing to each other.

As shown in FIG. 9(b), by opening the pair of the blades 11a1 and 11a2 and the pair of the blades 12a1 and 12a2 while making the V grooves 11d and 12d as a folding line, the metal foil laminates of the wound electrode group end surfaces, namely the compressed planar regions 120P of the positive and negative electrode collecting portions 122A and 124A can be push opened in a V-shape from the central portions thereof and divided left and right.

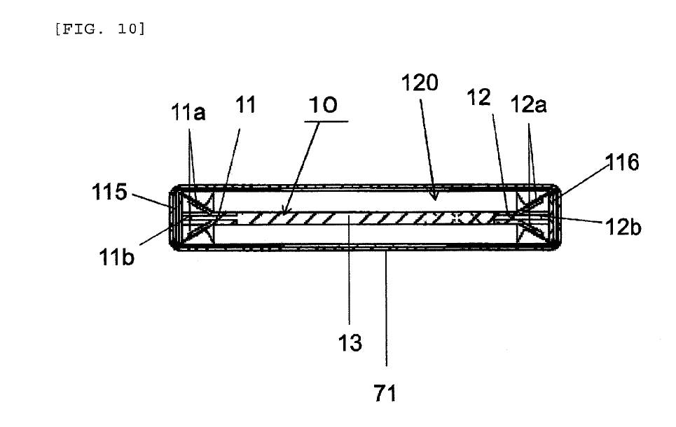

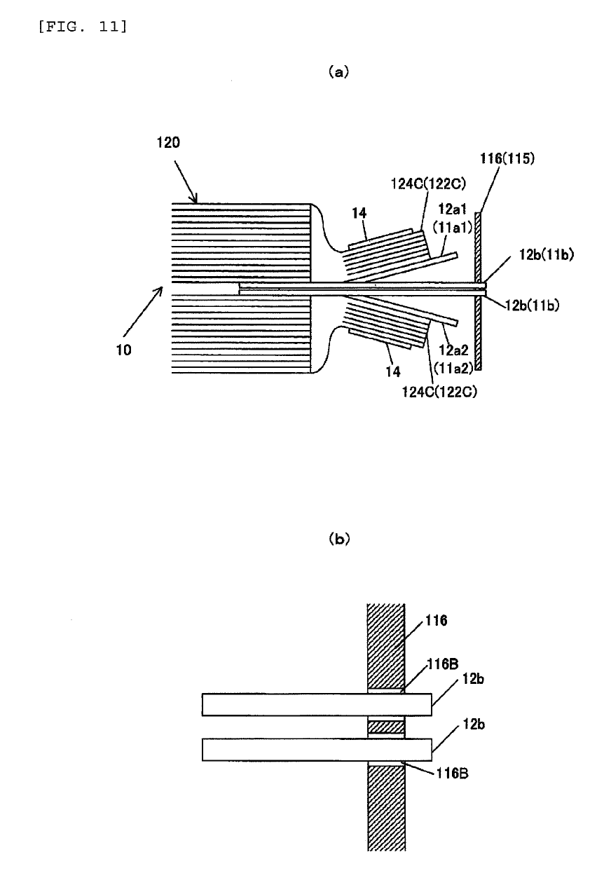

FIG. 10 is a transverse cross-sectional view of a secondary battery, and FIG. 11 is an enlarged view of a connection portion between the negative electrode shaft core portion 12 of the shaft core 10 and the negative electrode collector 116. As shown in FIGS. 10 and 11, the metal foil laminate of the wound electrode group end surface, namely the compressed planar region 120P of the negative electrode collecting portion 124A is push opened in a V-shape from the central portion thereof by the pair of the negative electrode blades 12a1 and 12a2 constituting the negative electrode spreading portion 12a and ultrasonically joined between stiffening plates 14. On the other hand, the pair of the negative electrode connection protrusions 12b is inserted into openings 116B of the negative electrode collector 116 and laser welded, whereby the negative electrode shaft core portion 112 and the negative electrode collector 116 are mechanically and electrically connected to each other. The positive electrode side is configured in the same manner.

Here, the size of each of the portions of the flat wound electrode group 120 is described by reference to FIGS. 2, 4 and 8.

As described above, an operation for push opening the positive and negative electrode collecting portions 122A and 124A from the inside by the positive and negative electrode spreading portions 11a and 12a, respectively is necessary. In consequence, the positive and negative electrode spreading portions 11a and 12a are protruded from the both end surfaces of the positive and negative electrode collecting portions 122A and 124A, respectively by only a value necessary for the operation. That is, a width W2 (see FIG. 8) of the positive or negative electrode spreading portions 11a or 12a is set up to a value larger than a width W20 (see FIG. 4) of the metal foil-exposed portion 122A or 124A. In addition, it is necessary to electrically connect the positive and negative electrode collecting portions 122A and 124A to the positive and negative electrode shaft core portions 11 and 12, respectively. Accordingly, a winding direction length W1 (see FIG. 8) of the pair of the protrusions 11a or 12a of the positive or negative electrode spreading portion 11a or 12a is set up to a value smaller than a winding direction length W10 (see FIG. 2) of the planar portion 120P in the positive or negative electrode collecting portion 122A or 124A.

### [Assembling of Power Generation Element Assembly]

The assembling procedures of the power generation element assembly 72 are described.

First of all, the flat wound electrode group 120 shown in FIG. 3 is fabricated. That is, the separator 121 is wound at least one round around the shaft core 10 shown in FIG. 5, and the positive electrode plate 122 and the negative electrode plate 124 are laminated and wound while allowing the separator 121 to intervene therebetween. The separator 121 of the outermost surface of the flat wound electrode group 120 is moored with a non-illustrated tape.

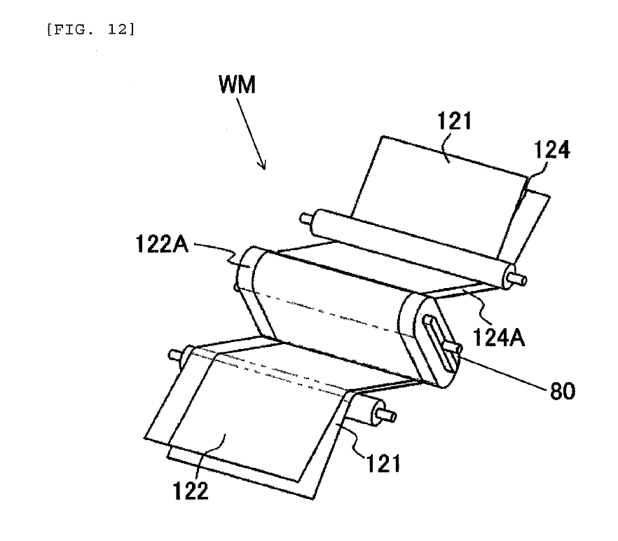

As shown in FIG. 12, in manufacturing the flat wound electrode group 120, a rotation shaft 80 of a winding machine WM is inserted between the two sheets of the positive and negative electrode shaft core portions 11 and 12 of the shaft core 10, and the positive electrode plate 122 and the negative electrode plate 124 are wound via the separator 121. According to this, the shaft core 10 can be easily disposed in the inside of the flat wound electrode group 120, so that the steps can be simplified.

Prior to the fabrication of the power generation element assembly 72 by integrating the flat wound electrode group 120 with the positive and negative electrode collectors 115 and 116, the non-coating portions 122A and 124A of the flat wound electrode group 120 are flattened in the thickness direction. The deformed planar region 120P is shown in FIG. 2.

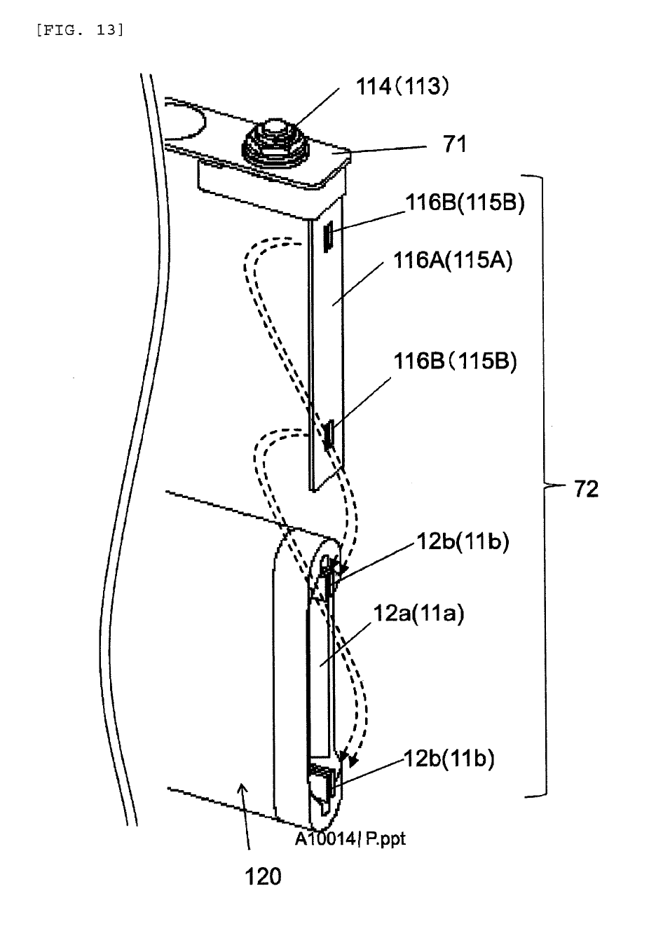

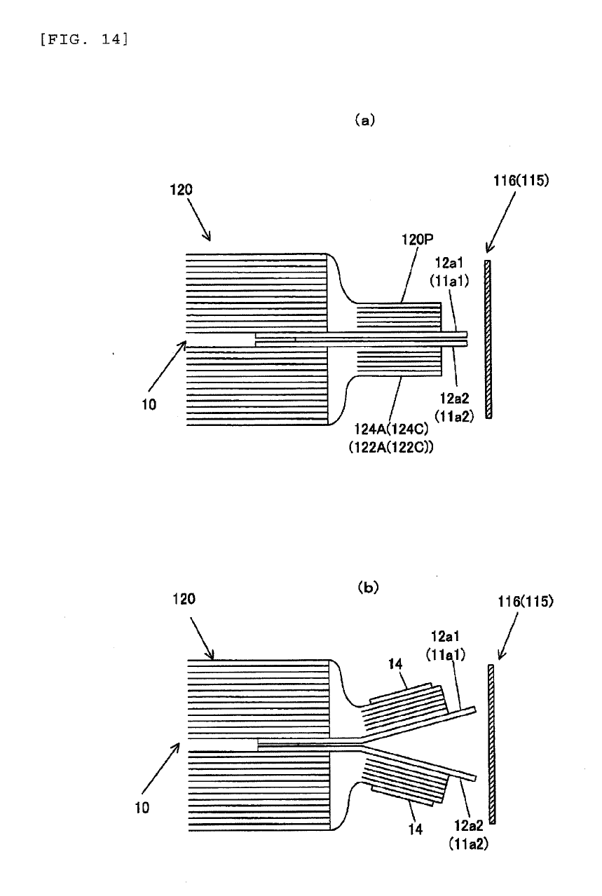

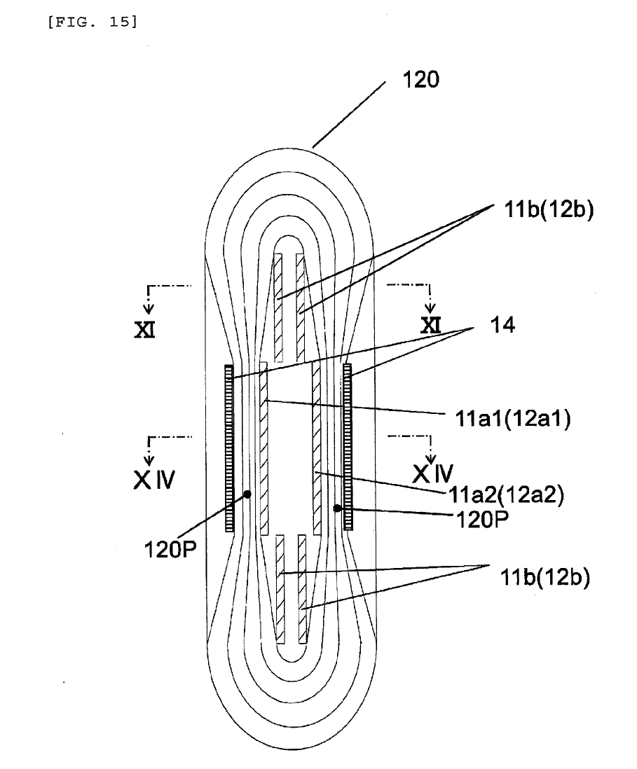

As shown in FIGS. 13 to 15, the metal-made negative electrode connection protrusion 12b of the shaft core 10 is inserted into the shaft core fixing opening 116B of the negative electrode collector 116 and laser welded. In addition, the metal-made negative electrode spreading blade 12a of the shaft core 10 is opened from the inside toward the outside of the electrode group 120 and opened in a V-shape as shown in FIG. 14(b). The planar portion 120P of the negative electrode laminate of the negative electrode collecting portion (positive or negative electrode non-coating portion) 124A is allowed to intervene between the spreading protrusion 12a1 of the negative electrode shaft core portion 12 and the stiffening plate 14 and sandwiched by non-illustrated horn and anvil, followed by ultrasonic joining. Similarly, the planar portion 120P of the negative electrode laminate is allowed to intervene between the spreading protrusion 12a2 of the negative electrode shaft core portion 12 and the stiffening plate 14 and sandwiched by non-illustrated horn and anvil, followed by ultrasonic joining. The positive electrode side is joined in the same manner.

In this way, the non-coating portions 122A and 124A of the wound electrode group 120 and the positive and negative electrode shaft core portions 11 and 12, and the positive and negative electrode shaft core portions 11 and 12 and the collectors 115 and 116, are electrically and mechanically connected to each other.

In the foregoing secondary battery of the first embodiment, the plural positive electrode connection protrusions 11b are provided at prescribed intervals at the end surface of the positive electrode shaft core portion 11; and the positive electrode collector 115 is integrated with the lid 111 of the battery vessel 71, extends toward the bottom portion PB of the battery vessel 71 along the width direction side surface PN of the battery vessel 71, and has the openings 115B into which the plural positive electrode connection protrusions 11b are inserted, respectively. Then, the respective positive electrode connection protrusions 11b are mechanically and electrically connected to the openings 115B of the flat plate 115A of the positive electrode collector 115, respectively.

In other words, the respective positive electrode connection protrusions 11b are provided in the both end portions of the end surfaces of the positive electrode shaft core portion 11, respectively, and the respective openings 115B of the positive electrode collector 115 are provided on the lid side and the battery vessel bottom portion side, respectively.

The negative electrode side is also the same.

Incidentally, since the positive electrode shaft core portion 11 and the negative electrode shaft core portion 12 are insulated from each other by the insulation portion 13, the external positive electrode terminal 113 and the external negative electrode terminal 114 are insulated from each other by the insulation portion 13 of the shaft core 10.

By laser welding the positive electrode shaft core portion 11 to the positive electrode collector 115, and the negative electrode shaft core portion 12 to the negative electrode collector 116, respectively, the electrode group 120 is surely fixed to the collectors 115 and 116. In addition, a current passage reaching the positive electrode plate 122 from the positive electrode external terminal 113 going through the positive electrode collector 115, the positive electrode connection protrusion 11b, and the positive electrode collecting portion 122A in success, or a current passage of the reverse direction, is formed. Similarly, a current passage reaching the negative electrode plate 124 from the negative electrode external terminal 114 going through the negative electrode collector 116, the negative electrode connection protrusion 12b, and the negative electrode collecting portion 124A in success, or a current passage of the reverse direction, is formed.

According to the foregoing assembling procedures, the flat wound electrode group 120 is mechanically and electrically joined with the positive and negative electrode collectors 115 and 116, whereby the power generation element assembly 72 is fabricated.

The method for manufacturing the secondary battery of the first embodiment as described above includes the following first step to fourth step.

### First Step:

A step of winding the positive electrode plate 122 and the negative electrode plate 124 via the separator 121 around the shaft core 10, thereby forming the wound electrode group 120 in a flat shape.

### Second Step:

A step of integrating the positive electrode shaft core portion 11 provided with the pair of the positive electrode blades 11a which push and expand a laminate 122c of the positive electrode plate 122 at the end surface of the wound electrode group 120 from the inside toward the outside and the protrusions 11b which connect the positive electrode collector 115 and the positive electrode shaft core portion 11 to each other, and the negative electrode shaft core portion 12 provided with the pair of the negative electrode blades 12a which push and expand a laminate 124c of the negative electrode plate 124 at the end surface of the flat wound electrode group 120 from the inside toward the outside and the protrusions 12b which connect the negative electrode collector 116 and the negative electrode shaft core portion 12 to each other via the insulation portion 13, thereby fabricating the shaft core 10.

### Third Step:

A step of connecting the positive and negative electrode shaft core portions 11 and 12 to the positive and negative electrode collectors 115 and 116, respectively.

### Fourth Step:

A step of not only spreading the pair of the positive electrode blades 11a to push and expand the laminate 122c of the positive electrode plate 122 at the end surface of the wound electrode group 120 from the inside toward the outside but spreading the pair of the negative electrode blades 12a to push and expand the laminate 124c of the negative electrode plate 124 at the end surface of the wound electrode group 120 from the inside toward the outside.

### Fifth Step:

A step of not only connecting the push expanded laminate 122C of the positive electrode plate 122 to the positive electrode blades 11a but connecting the push expanded laminate 124C of the negative electrode plate 124 to the negative electrode blades 12a.

In addition, the fifth step includes the following first ultrasonic welding step to fourth ultrasonic welding step.

### First Ultrasonic Welding Step:

A step of sandwiching the laminate 122c of the positive electrode plate 122 between the one side 11a1 of the pair of the positive electrode blades 11a and the stiffening plate 14 and positioning a vibrator and an anvil at the one side positive electrode blade 11a1 and the stiffening plate 14, respectively, followed by performing first ultrasonic welding.

### Second Ultrasonic Welding Step:

A step of sandwiching the laminate 122c of the positive electrode plate 122 between the other side 11a2 of the pair of the positive electrode blades 11a and the stiffening plate 14 and positioning a vibrator and an anvil at the other side positive electrode blade 11a2 and the stiffening plate 14, respectively, followed by performing second ultrasonic welding.

### Third Ultrasonic Welding Step:

A step of sandwiching the laminate 124c of the negative electrode plate 124 between the one side 12a1 of the pair of the negative electrode blades 12a and the stiffening plate 14 and positioning a vibrator and an anvil at the one side negative electrode blade 12a1 and the stiffening plate 14, respectively, followed by performing third ultrasonic welding.

### Fourth Ultrasonic Welding Step:

A step of sandwiching the laminate 124c of the negative electrode plate 124 between the other side 12a2 of the pair of the negative electrode blades 12a and the stiffening plate 14 and positioning a vibrator and an anvil at the other side negative electrode blade 12a2 and the stiffening plate 14, respectively, followed by performing fourth ultrasonic welding.

The square lithium ion secondary battery according to the first embodiment as described above can take the following actions and effects.

(1) The positive and negative electrode shaft core portions 11 and 12 are provided in the both end portions of the shaft core 10 of the wound electrode group 120, respectively, and the protrusions 11b and 12b for connecting the electrode group to the collector and the spreading portions 11a and 12a composed of the pair of the blades 11a1 and 11a2 and the pair of the blades 12a1 and 12a2, respectively are provided in the end portions thereof. The positive and negative electrode connection protrusions 11b and 12b of the shaft core portions 11 and 12 are inserted into the openings 115B and 116B of the positive and negative electrode collectors 115 and 116, respectively and laser welded.

In consequence, even in a secondary battery having a structure in which the electrode group 120 is hung from the lid 3, the shaft core portions 11 and 12 and the positive and negative electrode collectors 115 and 116 are mechanically and electrically joined with each other, so that the reliability against vibration can be enhanced.

In the light of the above, according to the present invention described in the first to sixth embodiments, by connecting the electrode collecting portions 122A and 124A to the shaft cores 10 or 10A to 10E, the wound electrode groups 120 and 220 in which the shaft core and the electrode wound body are integrated can be obtained; and by connecting the shaft core 10 or 10A to 10E directly to the collectors 115 and 116 to be connected to the external terminals 113 and 114, the shaft core supports the wound body itself, and therefore, a concern of breakage of the thin metal foils as the collecting portions 122A and 124A to be caused due to vibration can be decreased.

(2) In welding the positive and negative electrode plates 122 and 124 to the positive and negative electrode shaft core portions 11 and 12, the positive and negative electrode spreading protrusions 11a and 12a are spread, thereby push opening the laminates 122C and 124C at the end surfaces of the positive and negative electrode plates 122 and 124, respectively. Then, not only the positive electrode laminate 122C is sandwiched between the positive electrode spreading protrusion 11a and the stiffening plate 14 and welded, but the negative electrode laminate 124C is sandwiched between the negative electrode spreading protrusion 12a and the stiffening plate 14 and welded. Accordingly, the foil laminates 122C and 124C which are easily deformed or damaged can be easily spread, and the positive and negative electrode collecting portions 122A and 124A can be connected to the positive and negative electrode shaft core portions 11 and 12 without damaging the positive and negative electrode plates 122 and 124.
(3) Since the laminates 122C and 124C are push opened by the spreading protrusions 11a and 12a provided further inside the innermost peripheral foils of the non-coating portions 122A and 124A, respectively, there is no concern that the layer of the electrode foil to be expanded is mistaken or bitten. According to this, high work efficiency and high productivity can be realized, and the production cost can be reduced.
(5) In the spreading portions 11a and 12a, not only the spreading protrusions 11a1 and 11a2 and 12a1 and 12a2 to be operated manually or by a robot hand were provided, but these spreading protrusions 11a1 and 11a2 and 12a1 and 12a2 were made to protrude from the both end surfaces of the wound electrode group 120. In consequence, the spreading protrusions 11a and 12a can be simply operated.
(6) The shaft core 10 was configured to include the positive electrode shaft core portion 11 having the positive electrode spreading portion 11a provided in one end thereof, the negative electrode shaft core portion 12 having the negative electrode spreading portion 12a provided in the other end thereof, and the insulation portion 13 for integrating the positive electrode shaft core portion 11 and the negative electrode shaft core portion 12 while being insulated them from each other. In consequence, it is not necessary to separately provide an operation member for spreading the laminates 122C and 124C at the end surfaces of the wound electrode group 120, so that the number of parts can be decreased.
(7) The V grooves 11d and 12d were provided in the base ends of the protrusions 11a and 12a of the positive and negative electrode shaft core portions 11 and 12, respectively. Accordingly, the precision of folding of the positive electrode spreading portion 11a and the negative electrode spreading portion 12a is enhanced, and therefore, the costs of the steps of convergence, compression, and sandwiching of the positive electrode collecting portions 122A and 124A can be decreased.
(8) In the light of the above, in the both end portions of the insulation portion 13, the small-width, thin-walled insulation portion joint portions 13a and 13b are formed corresponding to the thicknesses of the positive and negative electrode shaft core portions 11 and 12 as compared with the central portion 13c, and the positive and negative electrode shaft core portions 11 and 12 are fit into the insulation portion joint portions 13a and 13b, respectively. According to this, the shaft core 10 has a shape in which the insulation portion 13 and the positive and negative electrode shaft core portions 11 and 12 are continued without a level difference, so that the flat wound electrode group 120 can be wound uniformly and in a high density.
(9) The width W2 of the winding shaft direction of the positive electrode spreading portion 11a and the negative electrode spreading portion 12a is larger than the width W20 of the winding shaft direction of the positive electrode collecting portion 122A and the negative electrode collecting portion 124A. In consequence, the work for opening the positive and negative electrode laminates 122C and 124C at the end surfaces of the electrode group 120 from the shaft core side toward the outside is easy.
(10) The length W1 of the winding direction of the wound electrode group 120 of the positive electrode spreading portion 11a and the negative electrode spreading portion 12a is shorter than the length W10 of the winding direction of the planar portion 120P of the positive and negative electrode collecting portions 122A and 124A. In consequence, the positive electrode spreading portion 11a and the negative electrode spreading portion 12a of the shaft core portions 11 and 12 are surely joined with the non-coating portions 122A and 124A of the electrode group 120, respectively.
(11) The positive and negative electrode shaft core portions 11 and 12 are each formed by folding one sheet of each of the metal plates 11m and 12m provided with the notches 11c and 12c and the V grooves 11d and 12d, and therefore, the production cost thereof is inexpensive.

### Second Embodiment

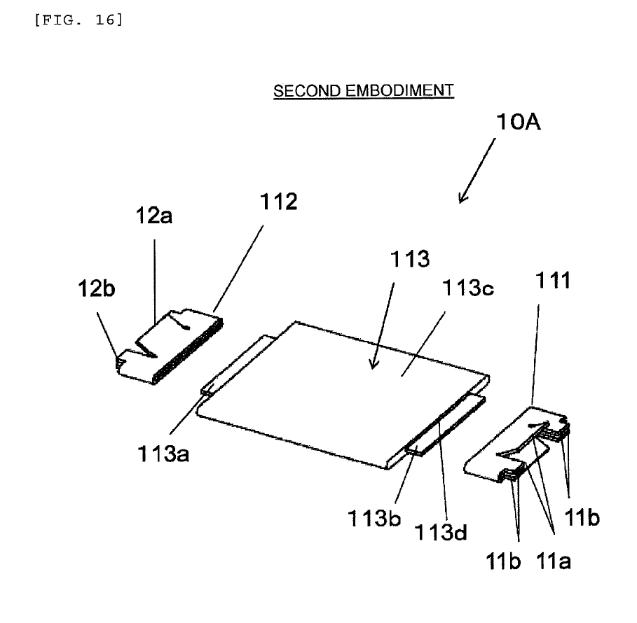

A second embodiment of the flat lithium ion secondary battery according to the present invention is described by reference to FIG. 16. Incidentally, in the drawing, the portions the same as or corresponding to those in the first embodiment are given the same symbols, and explanations thereof are omitted.

The second embodiment is concerned with one in which by making the width of the winding direction of the shaft core portion small, the volume of the metal material is decreased, thereby reducing the battery weight.

As shown in FIG. 16, similar to the first embodiment, a shaft core 10A of the wound electrode group 120 has negative and positive electrode shaft core portions 111 and 112 and an insulation portion 113. The insulation portion 113 is fabricated by, for example, a PPS resin having high heat resistance. The insulation portion 113 is configured of a thick plate main body 113c in the central portion and thin plate joint portions 113a and 113b protruding from the both ends of the main body 113c. In a connection portion between the thick plate main body 113c and each of the thin plate joint portions 113a and 113b, level differences 113d are formed. A size of these level differences 113d is made substantially equal to the thickness of the material of each of the positive electrode shaft core portion 111 and the negative electrode shaft core portion 112. In consequence, on the front and rear surfaces of the shaft core 10A, a level difference-free flat surface is formed.

Different from the first embodiment, in the thin plate joint portions 113a and 113b, the width of the winding direction thereof is smaller than the width of the thick plate main body 113c in the central portion, and similar to the thin plate joint portions 113a and 113b, the width of the winding direction of the positive and negative electrode shaft core portions 111 and 112 is smaller than the width of the thick plate main body 113c in the central portion.

According to this, the insulation portion 113 and the positive and negative electrode shaft core portions 112 and 111 are small as compared with those of the first embodiment, the weight of the shaft core 10A, in its turn, the weight of the lithium ion secondary battery, can be decreased.

Incidentally, as for the thickness, the shaft core 10A has a shape in which the insulation portion 113 and the positive and negative electrode shaft core portions 111 and 112 are continued without a level difference, so that the positive and negative electrode plates 122 and 124 and the separator 121 can be wound uniformly and in a high density around the shaft core 10A.

The second embodiment takes an effect for decreasing the battery weight in addition to the effects of the first embodiment.

### Third Embodiment

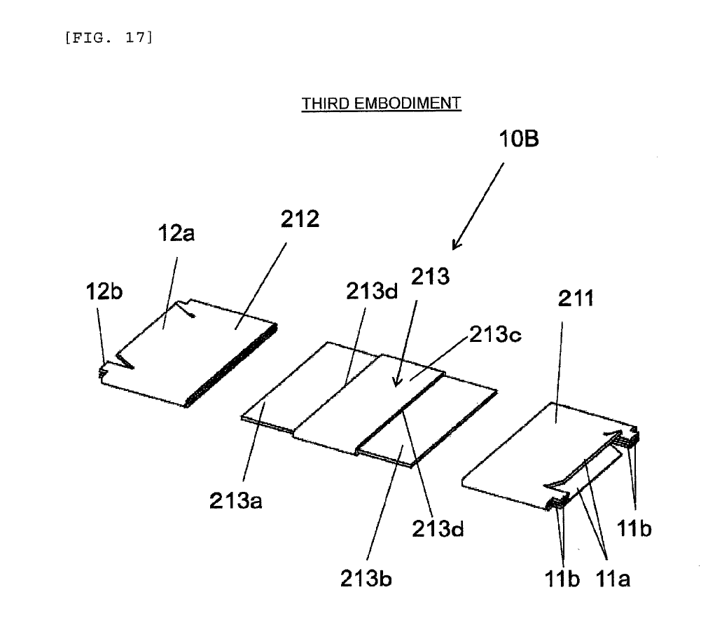

A third embodiment of the lithium ion secondary battery according to the present invention is described by reference to FIG. 17. Incidentally, in the drawing, the portions the same as or corresponding to those in the first embodiment are given the same symbols, and explanations thereof are omitted.

The third embodiment is concerned with one in which by making the length of the winding shaft direction of the shaft core portion longer, the strength of the shaft core is enhanced.

As shown in FIG. 17, similar to the first embodiment, a shaft core 10B of the wound electrode group 120 has positive and negative electrode shaft core portions 211 and 212 and an insulation portion 213. The insulation portion 213 is fabricated by, for example, a PPS resin having high heat resistance. The insulation portion 213 is configured of a thick plate main body 213c in the central portion and thin plate joint portions 213a and 213b protruding from the both ends of the main body 213c. In a connection portion between the thick plate main body 213c and each of the thin plate joint portions 213a and 213b, level differences 213d are formed. A size of these level differences 213d is made substantially equal to the thickness of the material of each of the positive electrode shaft core portion 211 and the negative electrode shaft core portion 212. In consequence, on the front and rear surfaces of the shaft core 10B, a level difference-free flat surface is formed.

In the second embodiment, the full length of the winding shaft direction of the insulation portion 213 is equal to the insulation portion 113 of the first embodiment. However, the length of the winding shaft direction of the thick plate main body 213c is made shorter, the length of the thin plate joint portions 213a and 213b is made longer, and the length of the winding shaft direction of the corresponding positive and negative electrode shaft core portions 211 and 212 is made longer.

In the shaft core 10B of the third embodiment, the positive and negative electrode shaft core portions 211 and 212 are larger than those in the first embodiment, and a superposing area (fitting area) between the insulation portion 213 and the positive and negative electrode shaft core portions 211 and 212 is larger. As a result, the strength of the shaft core 10B is increased, and the number of winding of the positive and negative electrode plates 122 and 124 is increased, so that a lithium ion secondary battery with a higher performance can be obtained.

Incidentally, similar to the first embodiment, the shaft core 10B has a shape in which the insulation portion 213 and the positive and negative electrode shaft core portions 211 and 212 are continued without a level difference, so that the positive and negative electrode plates 122 and 124 and the separator 121 can be wound uniformly and in a high density around the shaft core 10B.

The third embodiment takes an effect for increasing the shaft core strength in addition to the effects of the first embodiment.

### Fourth Embodiment

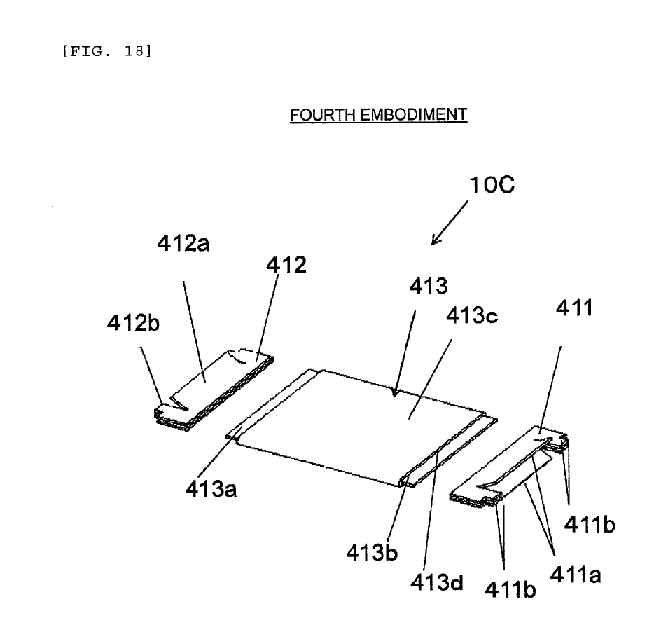

A fourth embodiment of the lithium ion secondary battery according to the present invention is described by reference to FIG. 18. Incidentally, in the drawing, the portions the same as or corresponding to those in the first embodiment are given the same symbols, and explanations thereof are omitted.

The fourth embodiment is concerned with one in which the shaft core portion is formed by sticking two sheets of metal plates.

As shown in FIG. 18, similar to the first embodiment, a shaft core 10C of the wound electrode group 120 has positive and negative electrode shaft core portions 411 and 412 and an insulation portion 413. The insulation portion 413 is fabricated by, for example, a PPS resin having high heat resistance. The insulation portion 413 is configured of a thick plate main body 413c in the central portion and thin plate joint portions 413a and 413b protruding from the both ends of the main body 413c. In a connection portion between the thick plate main body 413c and each of the thin plate joint portions 413a and 413b, level differences 413d are formed. A size of these level differences 413d is made substantially equal to the thickness of the material of each of the positive electrode shaft core portion 411 and the negative electrode shaft core portion 412. In consequence, on the front and rear surfaces of the shaft core 10C, a level difference-free flat surface is formed.

Similar to the first embodiment, in the positive and negative electrode shaft core portions 411 and 412, positive and negative electrode spreading portions 411a and 412a and connection protrusions 411b and 412b are formed, respectively. The fourth embodiment is different from the first embodiment at a point where the positive and negative electrode shaft core portions 411 and 412 are fabricated by laser joining two sheets of metal plates with the thin plate joint portions 413a and 413b of the insulation portion 413, respectively. That is, in the secondary battery of the fourth embodiment, the positive and negative electrode spreading portions 411a and 412a of the shaft core portions 411 and 412 and the connection protrusions 411b and 412b are formed by sticking of two sheets of metal plates,

The fourth embodiment takes the same effects as those in the first embodiment.

### Fifth Embodiment

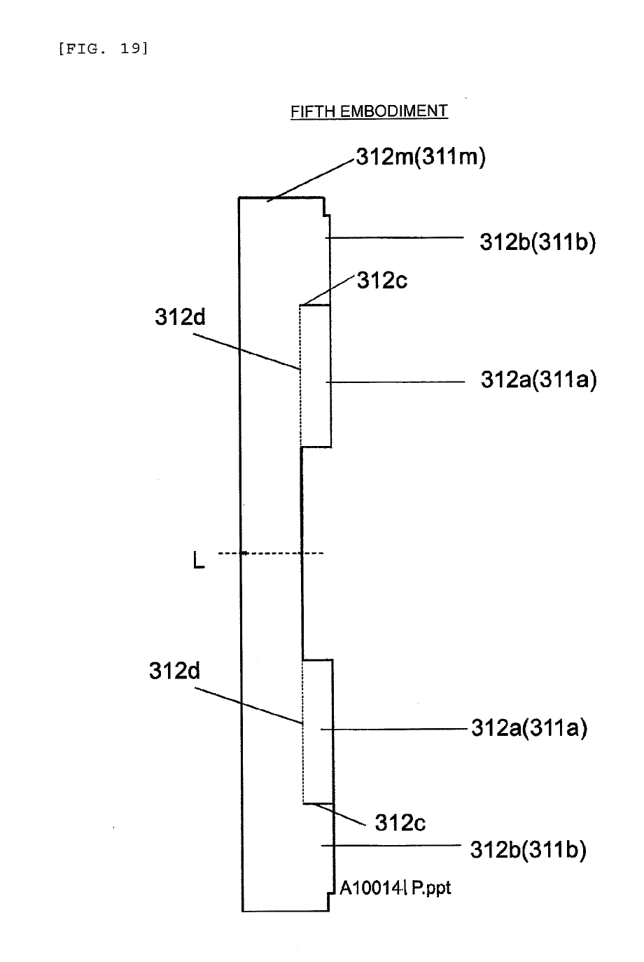

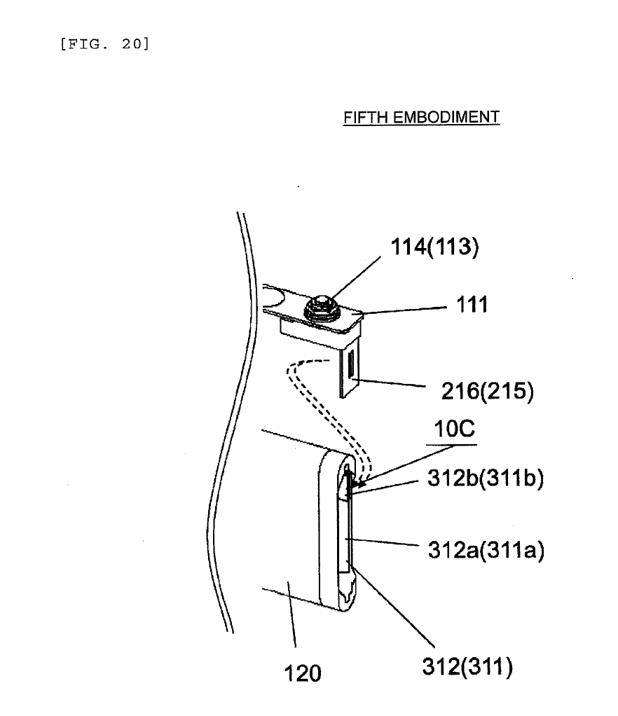

A fifth embodiment of the lithium ion secondary battery according to the present invention is described by reference to FIGS. 19 and 20. Incidentally, in the drawing, the portions the same as or corresponding to those in the first embodiment are given the same symbols, and explanations thereof are omitted.

The fifth embodiment is concerned with one in which by providing only one positive or negative electrode connection protrusion in a positive or negative electrode shaft core portion, the positive or negative electrode connection plate is miniaturized, thereby reducing the battery weight.

FIG. 19 is a view showing materials 311m and 312m of positive and negative electrode shaft core portions 311 and 312 in the shaft core 10D of the fourth embodiment. In the positive and negative electrode shaft core portion materials 311m and 312m, positive and negative electrode spreading portions 311a and 312a and regions serving as connection protrusions 311b and 312b are formed by a cutting line 312c and a folding V groove 312d, respectively. Then, the materials 311m and 312m are folded in half in a U-shape and superposed and laminated on thin-walled joint portions of an insulation portion in the same manner as that in the first embodiment.

The fifth embodiment is different from the first embodiment at a point where the positive and negative electrode connection protrusions 311b or 312b are singly provided in the shaft core portions 311 and 312, respectively. Then, in response to this, as shown in FIG. 20, flat plates 215A and 216A of positive and negative electrode collectors 215 and 216 are formed in a length such that they are shorter than the collectors of the first embodiment and extend toward only the upper side of the battery vessel 71. These positive and negative electrode collectors 215 and 216 are provided with two openings 215B and 216B, respectively. The positive and negative electrode connection protrusions 311b and 312b are inserted into the openings 215A and 216A, respectively and laser welded.

In the foregoing secondary battery of the fifth embodiment, only one positive electrode connection protrusion 311b is provided at the end surface of the positive electrode shaft core portion 311, and the positive electrode collector 215 is integrated with the lid 111 of the battery vessel 71. Then, the flat plate 315A of the positive electrode collector 315 extends toward the bottom portion PB of the battery vessel 71 along the width direction side surface PN of the battery vessel 71 and has the opening 215B into which one positive electrode connection protrusion 311b is inserted. The positive electrode connection protrusion 311b is inserted into each of the openings 215B of the positive electrode collector 215 and mechanically and electrically connected thereto.

In other words, the positive electrode connection protrusion 311b is provided in an end portion of the lid side of the end surface of the positive electrode shaft core portion 311, and the opening 315B of the positive electrode collector 315 is provided on the lid side. In addition, the flat plate 315A of the positive electrode collector 315 extends toward the bottom portion PB to a prescribed position exceeding the positive electrode connection protrusion 311b along the width direction side surface PN.

The negative electrode side is also the same.

The fifth embodiment is able to contrive to miniaturize the positive and negative electrode connection plates and to decrease the weight in addition to the effects of the first embodiment.

### Six Embodiment

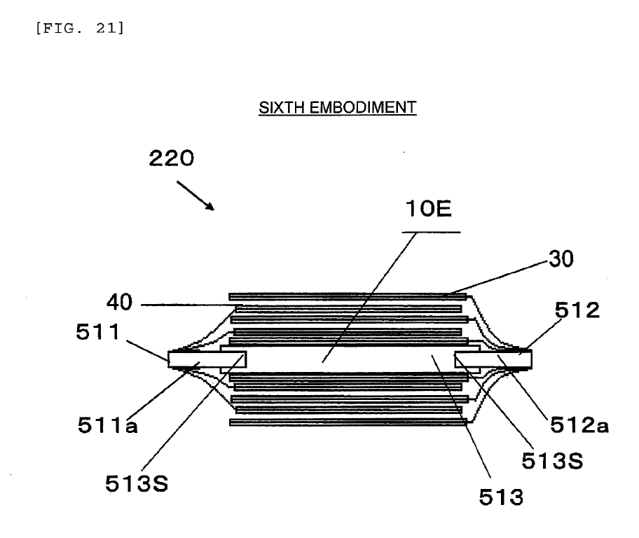

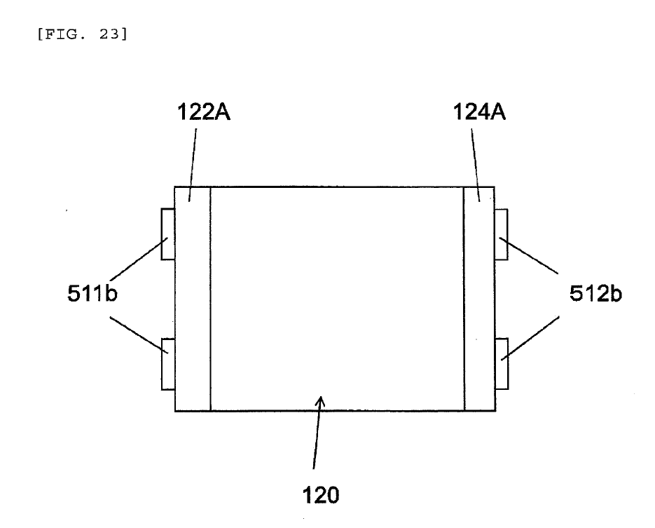

The sixth embodiment of the lithium ion secondary battery according to the present invention is described by reference to FIGS. 21 to 23. Incidentally, in the drawing, the portions the same as or corresponding to those in the first embodiment are given the same symbols, and explanations thereof are omitted.

The sixth embodiment is concerned with one in which the shaft core portion is formed by one sheet of metal plate.

FIG. 21 is a transverse cross-sectional view of a wound electrode group 220 in the sixth embodiment. As shown in FIG. 21, a shaft core 10E is provided with an insulation portion 513 in which fitting grooves 513S and 513S are formed respectively at the both end surfaces of the winding shaft direction and positive and negative electrode shaft core portions 511 and 512 fitted into the fitting grooves 513S and 513S, respectively. The positive and negative electrode shaft core portions 512 and 511 are adhered to the fitting grooves 513S and 513S by a pressure-sensitive adhesive or the like.

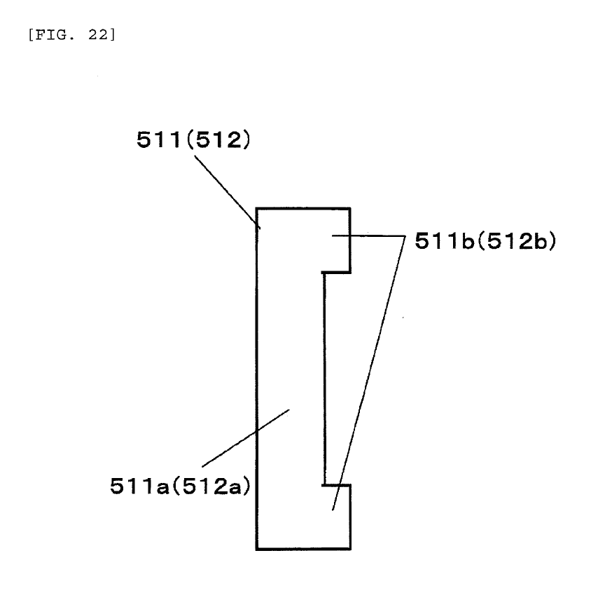

As shown in FIG. 22, the positive or negative electrode shaft core portion 511 or 512 is a flat plate formed in a U-shape. A positive or negative electrode connection protrusion 511b or 512b is formed in the both end portions at one end surface of the flat plate, and the central portion thereof is a positive or negative electrode joining portion 511a or 512a. The positive and negative electrode plates 122 and 124 are wound while allowing the separator 121 to intervene on the outer periphery of the shaft core 10E, the positive and negative non-coating portions 122A and 124A are laminated on the positive and negative electrode joining portions 511a and 512a, and the both are welded to each other by a non-illustrated laser welding machine. Incidentally, the positive and negative electrode joining portions 511a and 512a are joined with the laminate in a region shorter than the winding direction length W10 (see FIG. 2) of the electrode group planar portion 120P.

The sixth embodiment takes, in addition to the effects of the first embodiment, an effect for reducing the production cost of the shaft core 10 because the shaft core portion 512 or 511 is formed by one sheet of metal plate.

The method for manufacturing a secondary battery according to the first to sixth embodiments as described above includes the following steps:

a step of fabricating a vessel exterior having positive and negative electrode external terminals provided therein;

a step of winding positive and negative electrode plates while allowing a separator to intervene therebetween, to fabricate an electrode group provided with collecting portions at the both ends thereof;

a step of fabricating a shaft core in which the positive and negative electrode plates are wound and which has positive and negative electrode shaft core portions at the both ends thereof, the positive and negative electrode shaft core portions being insulated from each other by an insulation portion;

a step of fabricating positive and negative electrode collectors which are supported on the vessel exterior and constitute a current path reaching the positive and negative electrode external terminals from the electrode group;

a step of joining the positive and negative electrode shaft core portions with collecting portion laminates of the positive and negative electrode plates; and

a step of welding the positive and negative electrode shaft core portions to the positive and negative electrode collectors, respectively.

### Modification Examples

The foregoing embodiments can be carried out through the following modifications.

(1) While an example in which the positive electrode shaft core portion 11 is fabricated by aluminum, and the negative electrode shaft core portion 12 is fabricated by copper has been shown, the present invention should not be limited thereto. For example, there are no particular limitations so far as metal materials which are not corroded by a battery potential of each electrode and have conductivity, such as an aluminum alloy, a copper alloy, nickel, etc., are concerned.
(2) The insulation between the positive electrode shaft core portion 11 and the positive electrode collector 115, and between the negative electrode shaft core portion 12 and the negative electrode collector 116, was ensured by winding only the separator 121 at least one round around the shaft core 10 and performing winding in advance. An insulating separator other than the separator 60 may be wound around the shaft core 10.
(3) In the foregoing embodiments, amorphous carbon has been exemplified as the negative electrode active material. However, the present invention should not be limited thereto. Various graphite materials capable of inserting and releasing a lithium ion, natural graphite and artificial graphite, carbonaceous materials such as coke, etc., and the like may be useful. The particle shape thereof is not particularly limited, inclusive of flaky, spherical, fibrous, and block-like forms, and the like forms.
(4) In the foregoing embodiments, the collecting portions 122A and 124A of the positive and negative electrode plates 122 and 12 and the positive electrode shaft core portion 11 and the negative electrode shaft core portion 12 of the shaft core 10 were joined with each other by means of ultrasonic welding. However, there are no particular limitations so far as these members can be electrically joined by resistance welding or other joining method.
(5) In the foregoing embodiments, an example of using LiPF₆ as the electrolyte has been shown. However, the present invention should not be limited thereto. For example, LiClO₄, LiAsF₆, LiBF₄, LiB(C₆H₅)₄, CH₃SO₃Li, CF₃SOLi, and the like, and mixtures thereof can be used. In addition, in the present embodiments, an example of using a mixed solvent of EC and DMC as the solvent of the nonaqueous electrolytic solution has been shown. However, at least one or more mixed solvents such as propylene carbonate, ethylene carbonate, dimethyl carbonate, diethyl carbonate, 1,2-dimethoxyethane, 1,2-diethoxyethane, γ-butyl lactone, tetrahydrofuran, 1,3-dioxolane, 4-methyl-1,3-dioxolane, diethyl ether, sulfolane, methyl sulfolane, acetonitrile, propionitrile, propionitrile, etc. may be used, and a mixing blending ratio thereof is not limited.
(6) In the foregoing embodiments, PVDF was used as the binder of the joining agent layers 123 and 125 in the positive electrode plate 122 and the negative electrode plate 124. However, a polymer such as polytetrafluoroethylene (PTFE), polyethylene, polystyrene, polybutadiene, butyl rubber, nitrile rubber, styrene/butadiene rubber, polysulfide rubber, nitrocellulose, cyanoethyl cellulose, various latexes, acrylonitrile, vinyl fluoride, vinylidene fluoride, propylene fluoride, chloroprene fluoride, acrylic resins, etc., mixtures thereof, and the like can be used.
(7) In the foregoing embodiments, lithium manganate (LiMn₂O₄) of a stoichiometric composition has been exemplified as the positive electrode active material. However, other lithium manganese having a spinel crystal structure (for example, Li₁₊ₓMn₂₋ₓO₄), lithium manganese composite oxides in which a part of lithium manganate is substituted or doped with a metal element (for example, Li₁₊ₓM_{y}Mn_{2-x-y}O₄, wherein M is at least one member of Co, Ni, Fe, Cu, Al, Cr, Mg, Zn, V, Ga, B, and F), and lithium cobaltate or lithium titanate having a layered crystal structure, or lithium-metal composite oxides in which a part thereof is substituted or doped with a metal element may be used.
(8) In the foregoing embodiments, in the insulation portion 13 of the shaft core, for example, the PPS resin having high heat resistance was used, and the acrylic resin was used as the pressure-sensitive adhesive material. However, there are no limitations so far as a material capable of keeping insulation properties and having high adhesive strength is concerned.
(9) In the foregoing embodiments, the positive electrode shaft core portion 11 of the shaft core 10 and the positive electrode external terminal 113 were electrically connected to each other by the collector 115, and the negative electrode shaft core portion 12 of the shaft core 10 and the negative electrode external terminal 114 were electrically connected to each other by the negative electrode collector 116. However, this connection structure is not limited with respect to the shape and structure of the embodiments.
(10) In the foregoing, the secondary battery using the battery vessel 71 having a band-like transverse cross section and housing a flat wound electrode group therein has been described. However, the major characteristic feature of the present invention resides in the matter that in mechanically supporting the electrode group having the positive and negative electrode plates wound on the periphery of the shaft core while allowing the separator to intervene on the battery vessel, the breakage of the electrode group and the electrode foil to be caused due to vibration is prevented from occurring while taking into consideration the resistance of the current path reaching the external terminal from the electrode group via the collector. In consequence, the present invention can be applied to various secondary batteries in which the positive and negative electrode shaft core portions which are insulated from each other by the insulation portion are welded to the collecting portions (non-coating portions) of the positive and negative electrode plates, respectively, the positive and negative electrode shaft core portions are welded to the positive and negative electrode collectors, respectively, and the positive and negative electrode collectors are supported on the battery vessel.

The present invention can be applied to, in addition to the lithium ion secondary battery, various secondary batteries having a wound electrode group, such as a nickel hydrogen secondary battery, etc. In addition, the present invention can also be applied to various lithium ion capacitors having a wound electrode group.

1. A secondary battery comprising
a vessel exterior provided with positive and negative electrode external terminals;
an electrode group in which positive and negative electrode plates are wound while allowing a separator to intervene therebetween, and collector portions are provided at the both ends thereof;
a shaft core in which the positive and negative electrode plates are wound and which has positive and negative electrode shaft core portions at the both ends thereof, the positive and negative electrode shaft core portions being insulated from each other by an insulation portion; and
positive and negative electrode collectors which are supported by the vessel exterior and constitute a current path reaching the positive and negative electrode external terminals from the electrode group,
the positive and negative electrode shaft core portions being joined with collecting portion laminates of the positive and negative electrode plates and also welded to the positive and negative electrode collectors, respectively.

2. The secondary battery according to claim 1, wherein
the positive and negative electrode shaft core portions have
a positive electrode spreading portion and a negative electrode spreading portion which push and expand the positive electrode plate laminate and the negative electrode plate laminate, respectively from the insides at the both end surfaces of the electrode group and are joined with the positive electrode plate and the negative electrode plate, respectively and have
positive and negative electrode connection protrusions which are protruded from the both end surfaces of the electrode group and mechanically and electrically connected to the positive and negative electrode collectors, respectively.

3. The secondary battery according to claim 2, wherein
the positive electrode spreading portion includes a pair of positive electrode blades dividing the positive electrode plate in the both end surfaces of the electrode group, and the pair of the positive electrode blades are joined with the inner peripheries of the divided laminates, respectively; and
the negative electrode spreading portion includes a pair of negative electrode blades dividing the negative electrode plate laminate in the both end surfaces of the electrode group, and the pair of the negative electrode blades are joined with the inner peripheries of the divided laminates, respectively.

4. The secondary battery according to claim 3, wherein
plural positive electrode connection protrusions are provided at prescribed intervals at the end surface of the positive electrode shaft core portion;
the positive electrode collector is integrated with a lid of the vessel exterior, extends toward a bottom portion of the battery vessel along the width direction side surface of the battery vessel, and has openings into which the plural positive electrode connection protrusions are inserted, respectively;
plural negative electrode connection protrusions are provided at prescribed intervals at the end surface of the negative electrode shaft core portion;
the negative electrode collector is integrated with a lid of the vessel exterior, extends toward a bottom portion of the battery vessel along the width direction side surface of the battery vessel, and has openings into which the plural negative electrode connection protrusions are inserted, respectively;
the respective positive electrode connection protrusions are mechanically and electrically connected to the openings of the positive electrode collector, respectively; and
the respective negative electrode connection protrusions are mechanically and electrically connected to the openings of the negative electrode collector, respectively.

5. The secondary battery according to claim 4, wherein
the respective positive electrode connection protrusions are provided in the both end portions of the end surface of the positive electrode shaft core portion, respectively;
the respective openings of the positive electrode collector are provided on the lid side and the bottom portion side of the battery vessel, respectively;
the respective negative electrode connection protrusions are provided in the both end portions of the end surface of the negative electrode shaft core portion, respectively; and
the respective openings of the negative electrode collector are provided on the lid side and the bottom portion side of the battery vessel, respectively.

6. The secondary battery according to claim 3,
wherein
only one of the positive electrode connection protrusions is provided at the end surface of the positive electrode shaft core portion;
the positive electrode collector is integrated with a lid of the vessel exterior, extends toward a bottom portion of the battery vessel along the width direction side surface of the battery vessel, and has an opening into which the one positive electrode connection protrusion is inserted; only one of the negative electrode connection protrusions is provided at the end surface of the negative electrode shaft core portion;
the negative electrode collector is integrated with a lid of the vessel exterior, extends toward a bottom portion of the battery vessel along the width direction side surface of the battery vessel, and has an opening into which the one negative electrode connection protrusion is inserted;
the respective positive electrode connection protrusion is inserted into the opening of the positive electrode collector for mechanical and electrical connection, respectively; and
the negative electrode connection protrusion is inserted into the opening of the negative electrode collector for mechanical and electrical connection, respectively.

7. The secondary battery according to claim 6, wherein
the positive electrode connection protrusion is provided in an end portion on the lid side of the end surface of the positive electrode shaft core portion;
the opening of the positive electrode collector is provided on the lid side
the negative electrode connection protrusion is provided in an end portion on the lid side of the end surface of the negative electrode shaft core portion; and
the opening of the negative electrode collector is provided on the lid side.

8. The secondary battery according to claim 7, wherein
the positive electrode collector extends toward the bottom portion to a position exceeding the positive electrode connection protrusion along the width direction side surface, and
the negative electrode collector extends toward the bottom portion to a position exceeding the negative electrode connection protrusion along the width direction side surface.

9. The secondary battery according to claim 8, wherein
the insulation portion has a thin-walled joint portion at the bond ends thereof, and
the positive electrode shaft core portion and the negative electrode shaft core portion sandwich the thin-walled joint portion therebetween and are adhered with an insulating adhesive.

10. The secondary battery according to claim 9, wherein
the positive electrode shaft core portion and the negative electrode shaft core portion sandwich the thin-walled joint portion therebetween by folding one sheet of metal plate in a U-shape.

11. The secondary battery according to claim 9, wherein
in the positive electrode shaft core portion and the negative electrode shaft core portion, two sheets of metal plates are welded to the both surfaces of the thin-walled joint portion.

12. The secondary battery according to claim 10, wherein
in base ends of the pair of the positive electrode blades and the pair of the negative electrode blades, a groove for setting up a folding position of each of the pairs of positive and negative electrode blades is formed.

13. The secondary battery according to claim 1, wherein
the positive electrode shaft core portion and the negative electrode shaft core portion are connected to each other by allowing one sheet of metal plate to be fitted into the end surface of the insulation portion.

14. The secondary battery according to claim 1, wherein
the positive electrode plate includes a metal foil composed of aluminum or an aluminum alloy and a positive electrode joining agent layer coated on the both surfaces of the metal foil; the positive electrode shaft core portion is formed of a metal plate composed of aluminum or an aluminum alloy;
the negative electrode plate includes a metal foil composed of copper, a copper alloy, nickel, or a nickel alloy and a negative electrode joining agent layer coated on the both surfaces of the metal foil, and the negative electrode shaft core portion is formed of a metal plate composed of copper, a copper alloy, nickel, or a nickel alloy; and
the positive and negative electrode joining agent layers face each other and occlude and release a lithium ion.

15. A method for manufacturing a secondary battery comprising
a step of fabricating a vessel exterior having positive and negative electrode external terminals provided therein;
a step of winding positive and negative electrode plates while allowing a separator to intervene therebetween, to fabricate an electrode group provided with collecting portions at the both ends thereof;
a step of fabricating a shaft core in which the positive and negative electrode plates are wound and which has positive and negative electrode shaft core portions at the both ends thereof, the positive and negative electrode shaft core portions being insulated from each other by an insulation portion;
a step of fabricating positive and negative electrode collectors which are supported on the vessel exterior and constitute a current path reaching the positive and negative electrode external terminals from the electrode group;
a step of joining the positive and negative electrode shaft core portions with collecting portion laminates of the position and negative electrode plates; and
a step of welding the positive and negative electrode shaft core portions to the positive and negative electrode collectors, respectively.
